(19) United States
(12) Patent Application Publication
(10) Pub. No.: US 2010/0139661 A1
(43) Pub. Date: Jun. 10, 2010

(54) AIR BREATHING HOSE WITH INTEGRATED ELECTRICAL WIRING

(75) Inventor: Jeffrey L. Landis, Waxhaw, NC (US)

Correspondence Address: WYATT PRATT;SR. INTELLECTUAL PROPERTY COUNSEL, TYCO INTERNATIONAL LTD., ONE TOWN CENTER ROAD, BOCA RATON, FL, 33486, US

(73) Assignee: Scott Technologies, Inc., Monroe, NC (US)

(21) Appl. No.: 12/703,664

(22) Filed: Feb. 10, 2010

Related U.S. Application Data
(62) Division of application No. 10/739,752, filed on Dec. 18, 2003.

(51) Int. Cl. A62B 18/02; H01B 7/00

(52) U.S. Cl. 128/205.25; 174/113 R

(57) ABSTRACT

An integrated air hose assembly for a self-contained breathing apparatus. The air hose assembly includes a plurality of electrical wires embedded between an outer layer and an tube assembly. The tube assembly includes an inner tube forming a central air passage and an intermediate layer. Corresponding helical grooves are disposed in the outer surface of the intermediate layer and the inner surface of the outer layer, and the electrical wires are arranged therein in spaced relationship to one another.

### BACKGROUND OF THE PRESENT INVENTION

1. Field of the Present Invention

The present invention relates generally to self-contained breathing apparatuses, and, in particular, to air hoses and electrical wiring connecting a breathing tank carried on a user's back to a facepiece worn by the user.

2. Background

Self-contained breathing apparatuses (“SCBA's”) are commonly worn by individuals when carrying out activities in hazardous environments, such as when fighting fires and in other smoke- or gas-filled environments, in order to provide the wearer with breathable air. Conventional SCBA's generally include a facepiece, one or more pressurized cylinder or tank, and a hose. The facepiece, which covers the wearer's nose, mouth and eyes and includes a lens for external viewing, is supplied with air from the tanks via the hose. The tanks are secured to the wearer's body by a harness.

When using an SCBA, a person entering a hazardous environment will generally begin with a full tank of air, but it is obviously critical to monitor the remaining supply of air closely so that the user has sufficient time to exit the hazardous environment safely. Each tank's remaining air supply is determined on the basis of the tank's pressure. Pressure gauges have traditionally been mounted near the tank or hanging from the equipment worn on the user's back. Recently, however, the use of heads up displays (“HUD's”) has been incorporated into SCBA's. More particularly, the HUD provides the wearer (user) of a SCBA with a visual indication of the remaining supply of breathing gas (air) in the SCBA tank or tanks. Typically, a pressure transducer or pressure switch is used to generate an appropriate electrical signal, and a suitable circuit is utilized to provide a sequence of successive indications to the wearer as the air reserves dwindle. As mandated by the National Fire Protection Association, at least four supply levels are to be recognized and indicated; i.e., separate indications should be given when the tank is full, ¾ full ½ full and ¼ full. Each of these states may be reported to the wearer through the use of a HUD, mounted in the field of vision of the wearer, having, for example, four LED lights representing the four recommended levels.

In order to interconnect the HUD, worn on the user's head, to the pressure transducer or switch located with the tank on the user's back, an electrical circuit is typically provided. Such a circuit may include a plurality of electrical wires, all of which must extend from the user's back to his face. Additional wires may be incorporated for additional functions, such as providing additional status information, such as battery life or other data, from the equipment on the wearer's back to the HUD, for connecting head-mounted data input devices such as video recorders, microphones or vital sign sensors to the equipment on the wearer's back, or the like.

Because of the physical movements that may be required of the user while wearing and using the SCBA, it is highly important to minimize the effect of the wires on the wearer's movements. In addition, the wires, like the rest of the SCBA and the user himself, will frequently be subjected to extreme, damaging conditions that may include extremely high heat, flame, toxic air, water, and the like. As a result, one early approach was to route the wires with the air hose itself, thus preventing the wires from becoming entangled on the user or the user's equipment and providing some limited protection to the wires. However, such an approach is not ideal because the wires remain exposed to the elements.

In the field of medical technology, patient respirators are known which include electrical wires or heating devices embedded within the hose itself. For example, U.S. Pat. No. 4,621,633 to Bowles et al. discloses an electrical wire connecting a portable, wheel-mounted respirator device through an air hose to a digital thermometer, and a belt heater unit wrapped around the central air tube of the hose in order to heat air passing therethrough. Unfortunately, the linear approach is not adaptable to air hoses for SCBA's carried by firefighters because of its resulting effect on the flexibility of the air hose. More particularly, because metal wires are stiff and relatively inelastic by nature, the inclusion of any such wire within the body of an air hose has a negative effect on the flexibility of the hose. Wires routed linearly are incapable of stretching with the rest of the hose, thus placing severe stress on a hose that is, for example, stretched linearly or bent double.

On the other hand, if a single wire is embedded in an air hose in a helical arrangement, the coil formed by the wire may be expanded and contracted as the air hose is stretched or bent. Unfortunately, however, when multiple wires are coupled together, or when the wire or wire pair is arranged in the form of a belt, such as the belt heater disclosed by Bowles, the flexibility offered thereby is significantly restricted by the inelasticity of the coupled wires or belt. In other words, although such an arrangement is still capable of stretching axially, the belt or thick bundle of wires is not capable of bending significantly without a great deal of force, and is subject to destroying the overall shape of the hose or wire breakage if the hose is bent too far. Thus, although an arrangement such as the belt heater disclosed in the Bowles patent may be acceptable for patient respirators, where the patient does not typically move much in relation to the respirator itself, such an arrangement is not useful for SCBA's carried by firefighters and the like, where significantly greater amounts of flexibility are demanded. Thus, an air hose having embedded electrical wires that do not hamper the flexibility of the air hose is required.

There are other factors that affect the flexibility of a hose having electrical wires embedded therein. For example, if an electrical wire or bundle of electrical wires adheres to the hose materials in which it is embedded, then the wire or wires are not capable of moving independently from the materials around it, thus inhibiting flexibility. Further, in order to enhance the ability of the wires to move slightly back and forth as the material in which the wires are embedded is stretched, the hose body should ideally include a construction that enhances the ability of the wires to move slightly. Thus, an integrated air hose is needed that is constructed in such a way and from such materials so as to enhance the flexibility of the hose when wires are embedded therein.

### SUMMARY OF THE PRESENT INVENTION

The present invention comprises an integrated air hose assembly for connecting an air tank or other pressure vessel in a self-contained breathing apparatus to a facepiece. Such an air hose assembly includes a central air passage for transmitting breathing air to the user and one or more electrical wires disposed helically around the air passage for transmitting signals between equipment carried on the user's back and equipment carried on his head.

Broadly defined, the present invention according to one aspect includes an integrated air hose assembly having a body and two ends, wherein the body of the assembly includes a tube assembly having an inner surface and an outer surface, the inner surface defining a central air passage; an outer layer wrapped around the outer surface of the tube assembly, the outer layer having an inner surface and an outer surface; a helical groove formed in at least one of the outer surface of the tube assembly and the inner surface of the outer layer; and an electrical wire, arranged helically around the tube assembly and disposed in the helical groove.

In features of this aspect, the helical groove is formed in the outer surface of the tube assembly; the helical groove is formed in the inner surface of the outer layer; the helical groove is a first helical groove, a second helical groove is formed in the outer surface of the tube assembly, and the first helical groove is aligned with the second helical groove; the electrical wire is at least partially disposed in both the first and second helical grooves; the outer surface of the tube assembly and the outer layer are both formed from rubber or rubber-like materials; the outer surface of the tube assembly is formed from buna-N (nitrile) material, and the outer layer is formed from neoprene; the groove is a first groove, the electrical wire is a first electrical wire, the body of the integrated air hose assembly includes a second helical groove and a second electrical wire disposed therein, and the first groove and the first electrical wire are arranged in spaced relationship to the second groove and second electrical wire; and the two electrical wires are completely detached from each other, thus permitting the position of each wire to be adjusted relative to the other.

In another aspect of the present invention, an integrated air hose assembly has a body and two ends, and the body of the assembly includes an inner tube forming a central air passage; an intermediate layer surrounding the inner tube; an outer layer surrounding the intermediate layer; and one or more electrical wires disposed between the intermediate layer and the outer layer.

In features of this aspect, the one or more electrical wires are arranged helically around the intermediate layer; the integrated air hose assembly further includes a reinforcing sheath interposed between the inner tube and the intermediate layer; the inner tube, intermediate layer and outer layer are all formed from rubber or rubber-like materials; the intermediate layer is formed from buna-N (nitrile) material; the reinforcing sheath is formed from a synthetic woven material; the reinforcing sheath is formed from braided polyester; the one or more electrical wires are a plurality of electrical wires, wrapped helically around the inner tube in spaced relationship to one another; and each of the plurality of electrical wires is completely detached from the other electrical wires, thus permitting the position of each electrical wire to be adjusted relative to the remainder of the plurality of electrical wires.

In yet another aspect of the present invention, a self-contained breathing apparatus includes a pressure vessel for storing breathing air; an electrical signal generator, coupled to the pressure vessel, that generates at least one electrical signal on the basis of the remaining capacity of the pressure vessel; a facepiece; a user interface disposed at the facepiece; and a hose assembly, coupled at a first end to the pressure vessel and at a second end to the facepiece, having a hose having an inner surface and an outer surface, the inner surface defining a central air tube, and one or more electrical wires, each electrically coupled at a first end to the electrical signal generator and at a second end to the user interface, wherein the one or more electrical wires are disposed within the hose assembly between the inner surface and the outer surface of the hose.

In features of this aspect, the one or more electrical wires are wrapped helically around the central air tube; the user interface is a heads up display for indicating, to a user, the amount of gas remaining in the pressure vessel; the one or more electrical wires are a plurality of electrical wires, wrapped helically around the central air tube in spaced relationship to one another; and each of the plurality of electrical wires is completely detached from the other electrical wires, thus permitting the position of each electrical wire to be adjusted relative to the remainder of the plurality of electrical wires.

In still another aspect of the present invention, an integrated air hose assembly has a body and two ends, and the body of the assembly includes a tube assembly having an inner surface and an outer surface, the inner surface defining a central air passage; an outer layer wrapped around the outer surface of the tube assembly; and a plurality of electrical wires, each including a layer of insulation surrounding one or more wire strands, wherein the plurality of wires are arranged helically around the tube assembly, underneath the outer layer, in spaced relationship to one another.

In features of this aspect, the wires of the plurality of electrical wires are arranged such that the layers of insulation on the respective wires are generally not in contact with one another; the wires of the plurality of wires are evenly spaced around the tube assembly; at least two wires of the plurality of wires are electrically connected to one another at both ends of the hose assembly, but physically separate from one another intermediate the ends of the hose assembly, in order to provide redundancy; each wire of the plurality of wires is arranged such that linear distance required to complete one turn of wire is generally equivalent to twice the diameter of the outer surface of the tube assembly; the diameter of the outer surface of the tube assembly is about 7/16 inch and the linear distance required to complete one turn of wire is about ⅞ inch; and each of the plurality of electrical wires is completely detached from the other electrical wires, thus permitting the position of each electrical wire to be adjusted relative to the remainder of the plurality of electrical wires.

In still another aspect of the present invention, a self-contained breathing apparatus includes a pressure vessel for storing breathing air; an electrical signal generator, coupled to the pressure vessel, that generates at least one electrical signal on the basis of the remaining capacity of the pressure vessel; a facepiece; a heads up display disposed at the facepiece; and a hose assembly, coupled at a first end to the pressure vessel and at a second end to the facepiece, having an inner tube forming a central air passage, an intermediate layer surrounding the inner tube and having an outer surface, an outer layer wrapped around the outer surface of the tube assembly, the outer layer having an inner surface and an outer surface, a first set of helical grooves formed in the outer surface of the intermediate layer, a second set of helical grooves formed in the inner surface of the outer layer and aligned with the first set of helical grooves, and a plurality of electrical wires, each electrically coupled at a first end to the electrical signal generator and at a second end to the heads up display, arranged helically around the tube assembly and disposed in the helical grooves in spaced relationship to one another.

### BRIEF DESCRIPTION OF THE DRAWINGS

Further features, embodiments, and advantages of the present invention will become apparent from the following detailed description with reference to the drawings, wherein:

FIG. 1 is a schematic diagram of a self-contained breathing apparatus (“SCBA”) carried by firefighters, other emergency services workers, and the like, in accordance with the preferred embodiments of the present invention;

FIG. 2 is a perspective view of a hose assembly, in accordance with a first preferred embodiment of the present invention, shown interconnected with portions of the SCBA of FIG. 1;

FIG. 3 is a fragmentary perspective view of the hose assembly of FIG. 2, shown in isolation;

FIG. 4 is a cross-sectional view of the hose body of FIG. 3, taken along line 4-4, illustrating a plurality of electrical wires embedded therein;

FIG. 5 is a perspective view of a portion of the hose body of FIG. 3, shown with the outer layer removed, illustrating a preferred arrangement of the electrical wires;

FIG. 6 is a cross-sectional view of the friction layer of the hose body, shown in isolation;

FIG. 7 is a cross-sectional view of the outer layer of the hose body, shown in isolation;

FIG. 8 is an enlarged cross-sectional view of the pressure vessel end of the hose assembly of FIG. 3;

FIG. 9 is an enlarged cross-sectional view of the facepiece end of the hose assembly of FIG. 3, taken along line 9-9;

FIG. 10 is a perspective view of a hose assembly, in accordance with a second preferred embodiment of the present invention, interconnected with portions of the SCBA of FIG. 1;

FIG. 11 is an enlarged, fragmentary, reverse-angle cross-sectional views of the quick connect apparatus of FIG. 10, shown in an engaged state; and

FIG. 12 is an enlarged, fragmentary, reverse-angle cross-sectional views of the quick connect apparatus of FIG. 10, shown in a disengaged state.

### DETAILED DESCRIPTION OF THE PREFERRED EMBODIMENTS

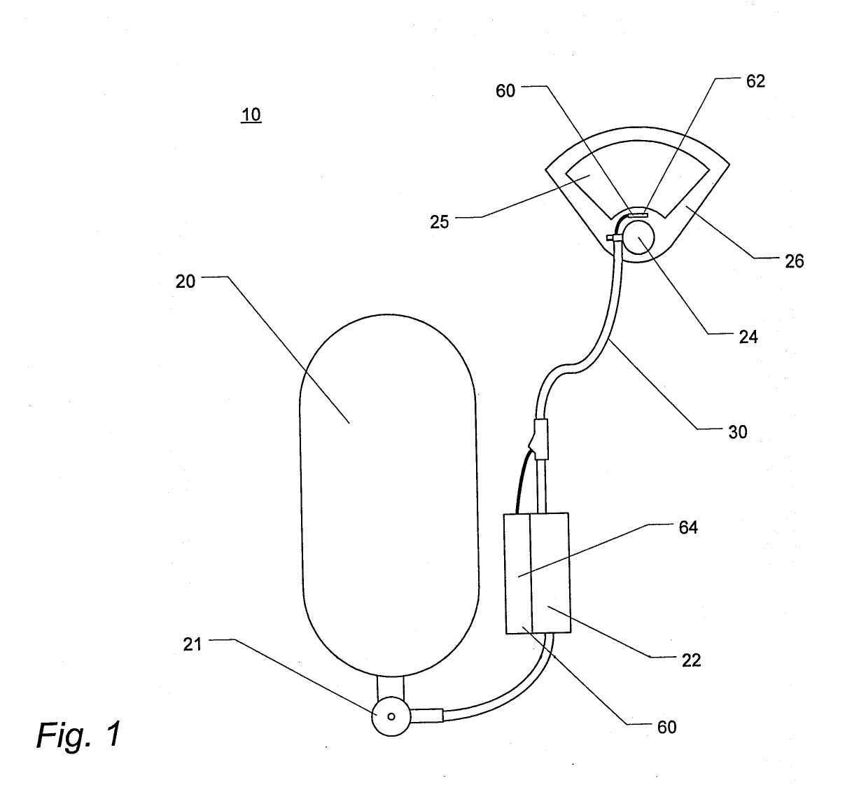

Referring now to the drawings, in which like numerals represent like components throughout the several views, the preferred embodiments of the present invention are next described. FIG. 1 is a schematic diagram of a self-contained breathing apparatus (“SCBA”) 10 carried by firefighters, other emergency services workers, and the like, in accordance with the preferred embodiments of the present invention. The SCBA 10 includes one or more pressure vessel 20, one or more pressure reducers or regulators 22, 24, a facepiece 26, a hose assembly 30 and an electrical system 60. The pressure vessel 20 is a pressurized cylinder or tank that provides a supply of breathing air to the wearer. In one preferred form of the invention the tank 20 may be of a type that initially holds air at a pressure of about 316.4 kg/sq.cm. (4500 PSIG). The tank 20 may include a conventional outlet valve 21 and pressure gauge (not shown). A first stage regulator 22 is preferably disposed adjacent the outlet valve 21 of the tank 20 and in fluid communication therewith. The first stage regulator 22 includes a regulator chamber (not shown) in which the fluid pressure is maintained at approximately 7.03 Kg./sq.cm (100 PSIG). The first stage regulator 22 may be any regulator of conventional design.

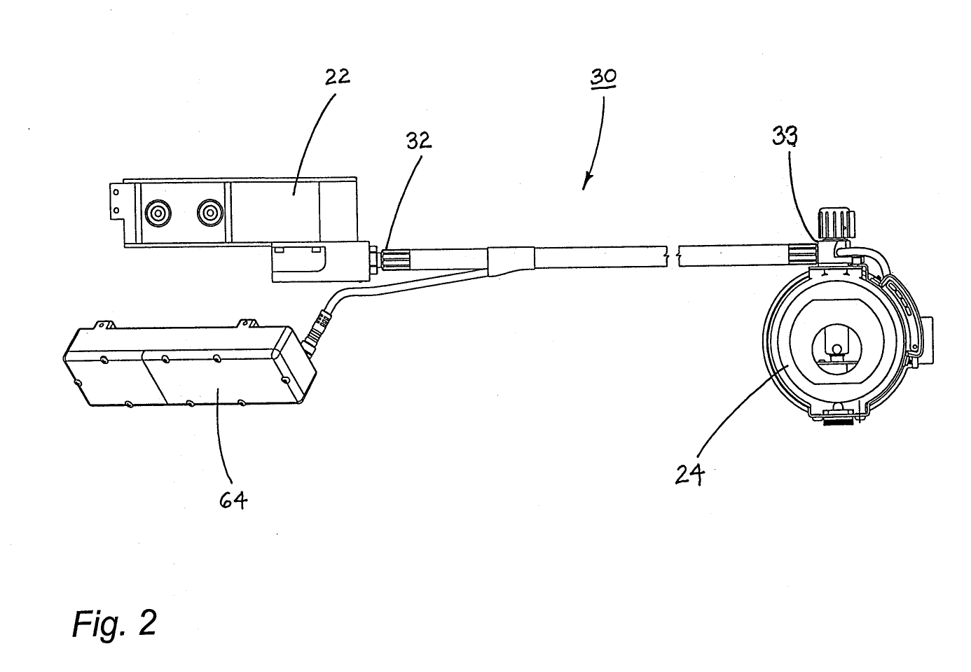

FIG. 2 is a perspective view of a hose assembly 30, in accordance with a first preferred embodiment of the present invention, shown interconnected with portions of the SCBA 10 of FIG. 1. The regulator chamber is in fluid communication, through an outlet, with the hose assembly 30, which is connected via couplings 32, 33 between the first stage regulator 22 and the facepiece 26 via a breathing regulator 24 that serves as a second stage regulator. The breathing regulator 24, which is preferably disposed on the facepiece 26 as seen schematically in FIG. 1, includes a second regulator chamber (not shown) in fluid communication with the hose assembly 30. The facepiece 26 covers the wearer's nose and mouth in airtight connection, and preferably covers the wearer's eyes with a transparent shield 25 for external viewing. The breathing regulator 24 may be any one of a number of conventional or novel types, including demand type regulators or positive pressure type regulators.

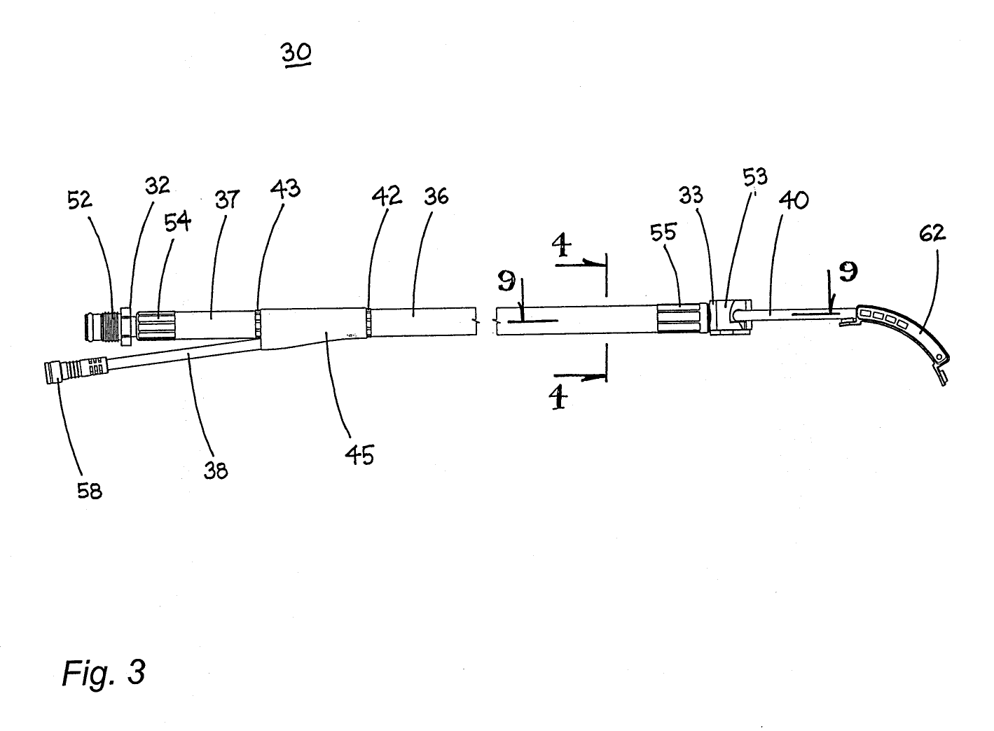

FIG. 3 is a fragmentary perspective view of the hose assembly 30 of FIG. 2, shown in isolation. The hose assembly 30 includes an air supply hose and an electrical harness. The electrical harness includes one or more electrical cables or wires 39, each of which may include one or more strands of wire surrounded by an insulation layer. The wires 39 and wire strands may be of conventional construction. In one commercial embodiment, each wire 39 includes 19 strands of 38 AWG silver-plated copper, and the insulation layer is formed from Teflon or another fluoropolymer. However, it will be clear that other sizes and materials of conductive material may be employed for the wire strands, and that the insulation layer may be any suitable electrically insulative, low-friction material. It will also be apparent that the principles disclosed herein are equally applicable to fiber optic cables and the like.

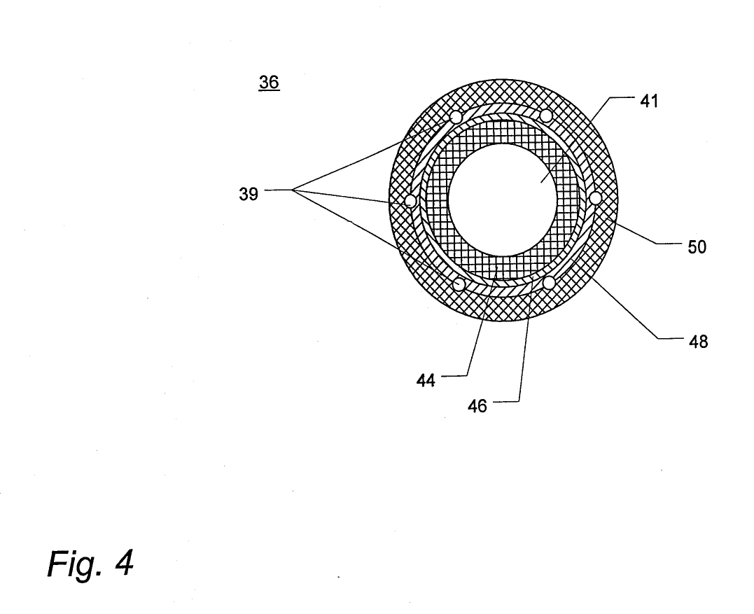

The air supply hose is a flexible, semi-rigid, multi-layered tube arranged to permit the unrestricted flow of breathing air through a central passage 41 defined by the innermost wall thereof. The air supply hose includes a hose body 36 and at least a pair of couplings 32, 33. FIG. 4 is a cross-sectional view of the hose body 36 of FIG. 3, taken along line 4-4, illustrating a plurality of electrical wires 39 embedded therein. The hose body 36 includes a tube assembly, including an inner tube 44, a reinforcing sheath 46 wrapped around the inner tube 44 and an intermediate layer 48 disposed around the reinforcing sheath 46, and an outer layer 50 wrapped around the intermediate layer 48. The inner tube 44, reinforcing sheath 46 and outer layer 50 may be of conventional materials, which include rubber or rubber-like materials for the inner tube 44 and outer layer 50 and woven materials for the reinforcing sheath 46. In one embodiment suitable for use in the preferred embodiments of the present invention, the inner tube 44 may be formed from buna, the reinforcing sheath 46 may be a single layer of braided polyester, and the outer layer 50 may be formed from neoprene. The various layers may be formed on top of each other using conventional extrusion processes, starting with the inner tube 44 being formed on a mandrel.

The intermediate, or friction, layer 48 is formed around the polyester braid 46 in order to provide a suitable mounting surface for the electrical wires 39. The friction layer 48 provides friction and structural support during manufacturing in order to keep the wires 39 in place while the outer layer 50 is applied, and preferably supplements the outer layer 50 with enough structural support to retain the wires 39 in place during use of the hose assembly 30. Preferably, for durability, resiliency and protection from the external environment, the friction layer 48 is formed from a rubber or rubber-like material. Further preferred characteristics of the friction layer material are described hereinbelow.

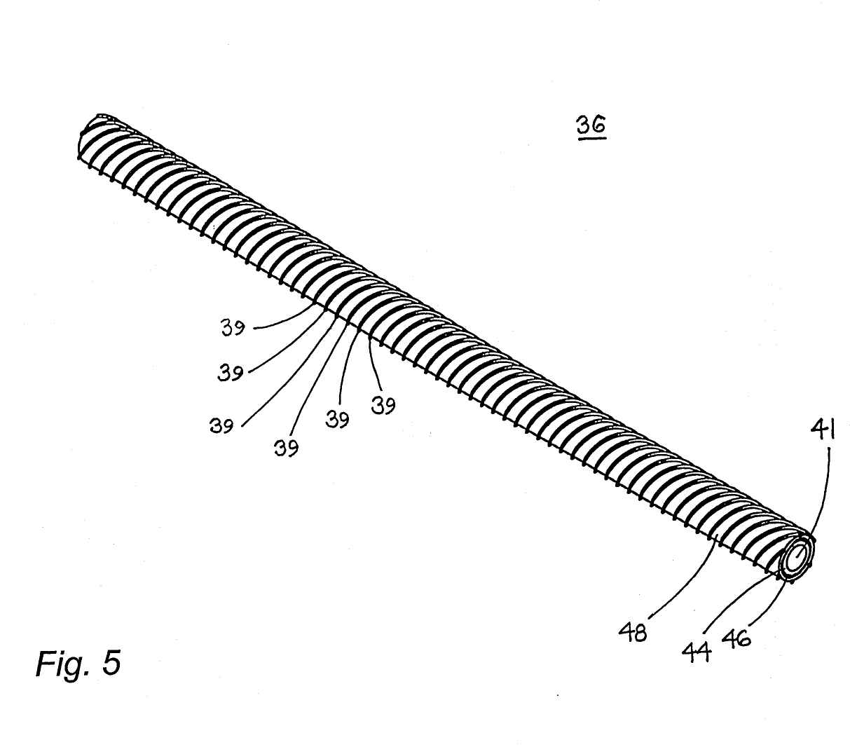

FIG. 5 is a perspective view of a portion of the hose body 36 of FIG. 3, shown with the outer layer 50 removed, illustrating a preferred arrangement of the electrical wires 39. As shown therein, the electrical wires 39 are arranged helically around the surface of the friction layer 48. Although the illustrated embodiment makes use of six wires 39, it should be apparent that other numbers of wires 39 may likewise be utilized without departing from the scope of the present invention. Importantly, the wires 39 are arranged in spaced relationship to one another around the hose body 36. Because the metal in the wires 39 is generally inelastic, the wires 39 make the hose assembly 30 stiffer wherever they are placed, thus inhibiting the flexibility of the hose assembly 30. However, by spacing the wires 39 around the periphery of the friction layer 48, the stiffness of the hose assembly 30 in any one area is decreased. Ideally, the wires 39 are uniformly distributed around the periphery of the friction layer 48, thus making the hose assembly 30 uniformly flexible. However, it should be apparent that some benefit may also be gained merely by spacing the wires 39 apart, by grouping pairs or trios of wires 39 together and spacing the pairs around, or by other similar techniques.

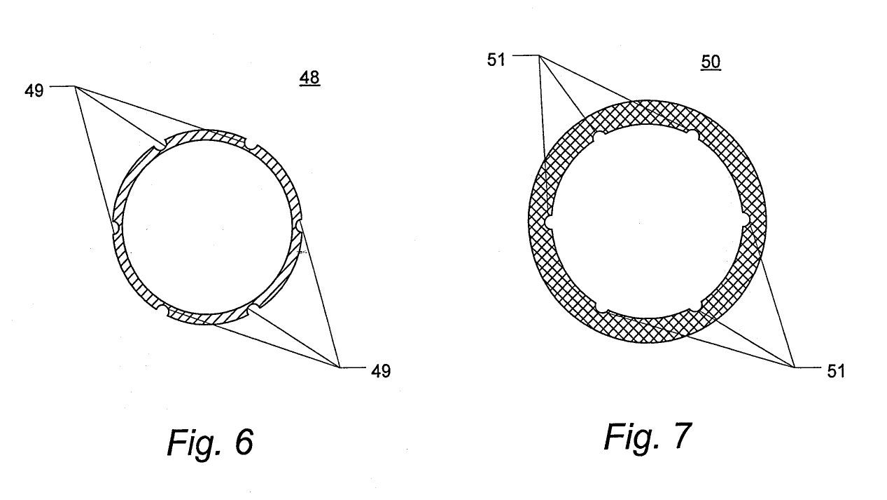

In the finished hose body 36, the wires 39 are preferably disposed in grooves 49, 51 formed in the outer surface of the friction layer 48 and the inner surface of the outer layer 50. The grooves 49, 51 are perhaps best illustrated in FIGS. 6 and 7, which are cross-sectional views of the friction layer 48 and outer layer 50 of the hose body 36, respectively, shown in isolation. Use of the grooves 49, 51 helps minimize the overall thickness of the hose assembly 30 and provides a channel for the wires 39 disposed therein to move slightly when the hose is stretched or bent. Although the grooves 49, 51 may be formed prior to installation of the wires 39, for ease of manufacturing it is preferable to use materials for the friction layer 48 and outer layer 50 that may be easily molded. One material suitable for use as a friction layer 48 in the preferred embodiments of the present invention is a buna-N (nitrile) material, which can be applied using the same conventional extrusion processes as the other materials. After the friction layer 48 is applied, but before it cures, the wires 39 may be wrapped around the friction layer 48 under heat and pressure such that the wires 39 press into its outer surface, thereby forming the grooves 49 shown in FIG. 6. Similarly, if neoprene or a similar material is utilized as the outer layer 50, the material may be applied to the wires 39 under heat and pressure such that the wires 39 press into the inner surface of the outer layer 50, thereby forming the grooves 51 shown in FIG. 7. Once all of the materials are cured or otherwise finished, the wires 39 are thus effectively sealed off from the central air passage 41 by the inner tube 44 and the friction layer 48, and are protected from the external environment by the outer layer 50.

Returning to FIG. 3, each hose coupling 32, 33 includes a respective air flow fitting 52, 53 attached in an end of the hose body 36 by a ferrule 54, 55. Preferably, in order to minimize potential damage to the electrical wires 39, the ferrules 54, 55 are compression-mounted to the respective ends of the hose body 36 by applying force linearly, rather than radially. Conventional fittings, such as standard banjo-type regulator fittings or standard QD sockets, may be utilized, but it may be desirable to modify such conventional fittings to incorporate features directed toward routing the electrical wires 39 around or through the fittings 52, 53. For example, FIGS. 2 and 3 illustrate one proposed commercial embodiment in which one air flow fitting 52 is a standard threaded fitting, while the air flow fitting 53 at the other end of the hose body 36 is a banjo-type regulator fitting having a cylindrical bore 56, offset from the center axis of the hose body 36, for accommodating an electrical cable as described below. It will also be apparent to those of ordinary skill in the art that other types of couplings and fittings may likewise be utilized without departing from the scope of the present invention.

As shown in FIG. 1, the electrical system 60 typically includes one or more facepiece-mounted communication or other electrical device 62 connected to a controller 64 or the like, carried with the other equipment on the wearer's back, via the electrical harness. As exemplified in FIG. 3, each end of the electrical harness may be integrally attached to the communication device 62, may be terminated in a physical connector 58, or the like. Because these termination points may be physically separated from the termination points for the hose, as shown in FIG. 2, the hose assembly 30 may be bifurcated at one or both ends into a hose portion and an electrical portion. For example, in the commercial embodiment illustrated in FIG. 3, one end of the hose assembly 30 is bifurcated into a hose portion, comprising a length of conventional air hose 37, and an electrical portion, comprising a segment of multi-wire electrical cable 38.

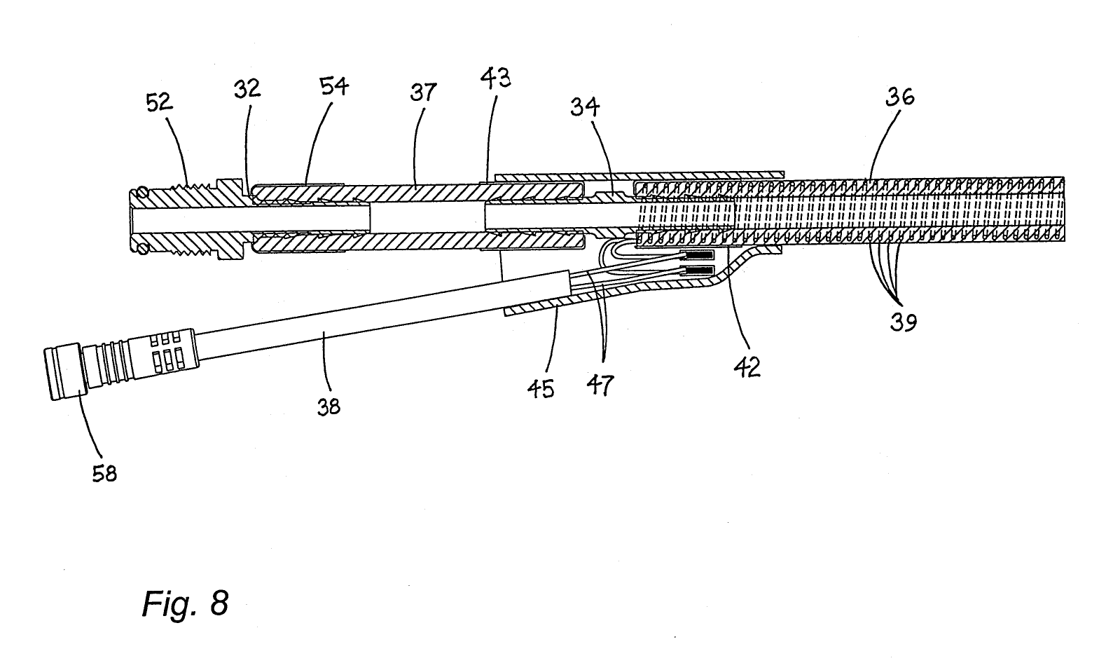

FIG. 8 is an enlarged cross-sectional view of the pressure vessel end of the hose assembly 30 of FIG. 3. As particularly shown therein, the main hose body 36 may be connected to the length of conventional hose 37 via an appropriate coupling 34 that may be retained in the respective hose sections 36, 37 by ferrules 42, 43 of similar construction to those described previously. The cable segment 38 includes a plurality of electrical wires 47 surrounded by a sheath of protective material, such as neoprene. The wires 47 in the cable segment 38 are electrically connected to the wires 39 in the main hose body 36. The electrical connections may be made by jumpering or otherwise physically connecting the respective wires together, or the wires 39 may run continuously through both the main hose body 36 and the cable segment 38. A protective sleeve 45, formed from neoprene or the like, may be wrapped around the assembled coupling 34, ferrules 42, 43, and electrical connections.

Optionally, additional reliability may be imparted to the electrical harness portion of the hose assembly 30 by using redundant wires 39. In other words, each electrical input/output in the connector 58 may be electrically connected to two or more separate wires 39 in the electrical harness. For example, in the illustrated embodiment, the connector 58 may include three input/outputs, each of which is electrically connected to two of the six wires 39 shown in FIGS. 4 and 5. Thus, the six wires 39 form only three signal paths, with the extra wires providing the hose assembly 30 with greater reliability than if each signal were carried on only one wire 39. Connections between the inputs/outputs in the connector 58 and the wire pairs may be made, for example, within the connector 58 itself or via the electrical connections in the protective sleeve 45. Significantly, if redundant wires 39 are indeed utilized, the importance of minimizing the effect of the electrical harness on the flexibility of the hose assembly 30 becomes still greater because of the presence of these additional wires 39, thus making the helical arrangement and spaced relationship of the wires 39 that much more critical.

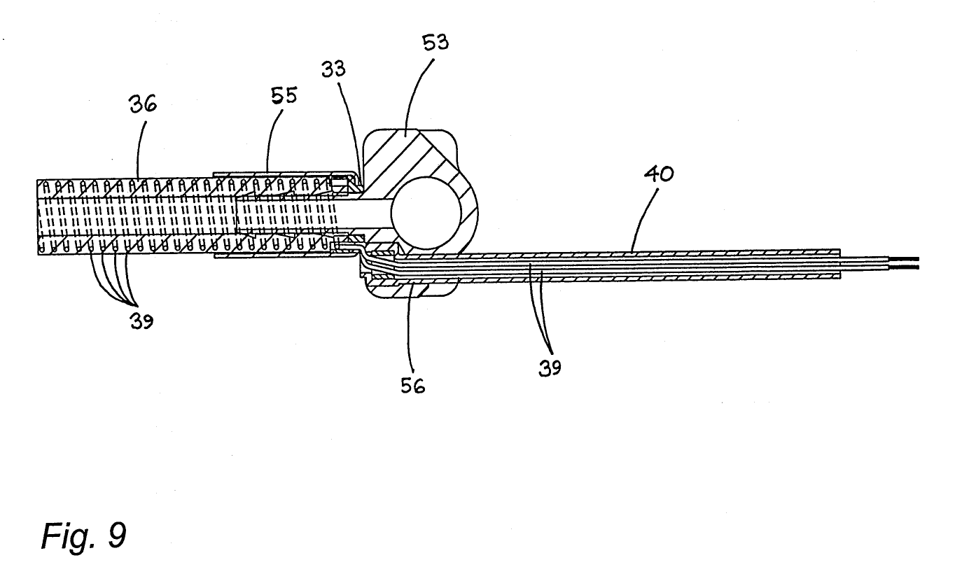

If necessary, the end of the hose may be extended beyond the end of the electrical harness, or vice versa. For example, in the commercial embodiment illustrated in FIG. 3, the electrical harness includes an additional segment of multi-wire cable 40 that extends past the end of the hose body 36, which terminates in the coupling 33. FIG. 9 is an enlarged cross-sectional view of the facepiece end of the hose assembly 30 of FIG. 3, taken along line 9-9. As shown therein, this cable segment 40, like the one described previously, includes a plurality of electrical wires surrounded by a sheath of protective material, such as neoprene. The wires in the cable segment 40 are a continuation of those in the hose body 36, but alternatively the wires in the cable segment 40 may be separate wires, electrically connected to the wires 39 in the main hose body 36 by jumpering or otherwise physically connecting the respective wires together. The cable segment 40 is routed through the coupling 33 via a cylindrical bore 56 in the air flow fitting 53 in order to protect the cable segment 40, to make routing more straightforward, and the like. However, it should be apparent that other arrangements may be utilized to route the wires 39 through or around the fitting 53 shown, or any other fitting, without departing from the scope of the present invention. Moreover, a variety of arrangements, electrical connection means, physical connectors and electrical devices suitable for use in this and other locations in the hose assembly 30 will be apparent to those of ordinary skill in the art.

Although in cross-section the hose body 36 is generally circular in shape, as illustrated in FIG. 4, the outer layer 50 of the hose body 36 has a non-uniform thickness, best shown in FIG. 6, as a result of the grooves 51 formed in the inner surface thereof. Because the outer layer 50 is thus much weaker along the grooves 51 than in other areas, a technician or other user may readily tear the outer layer 50 along any of the grooves 51. This construction thus facilitates the controlled removal of a section of the hose's outer layer 50 as necessary in order to expose the insulated wires 39 for use. In order to accomplish this, the hose body 36 may be scored circumferentially at the desired location, which then permits the outer layer 50 to be torn and peeled off along one or more of the grooves 51 until the score line is reached.

In a typical commercial embodiment, the electrical harness is electrically connected at one end to a heads up display (“HUD”) 62, mounted in or on the facepiece 26, and at the other end to a bottle pressure sensor system (not shown). The bottle pressure sensor system typically includes a pressure transducer or pressure switch that is used to generate one or more appropriate electrical signals for transmission to the HUD 62. The HUD 62 includes one or more light sources, such as LED's, for providing a sequence of successive visual indications to the wearer as the air reserves in the tank 20 dwindle, and for warning the user when the sensor system's battery life drops too low.

The use of such HUD's, mounted in the field of view of the user, has recently been strongly encouraged for reporting the amount of air remaining in a tank 20 to the tank's user, and thus the HUD is an excellent example of an electrical device 62 that is mounted on the facepiece 26 and requires an electrical connection from a piece of equipment carried on the user's back. However, a wide variety of applications for the hose assembly 30 of the present invention will be readily envisioned and understood by those of ordinary skill in the art. Such applications may include, without limitation, the use of the wires to electrically connect a microphone, speaker, video capture or display device, vital sign sensors, or the like to a recording device or transceiver device carried with the tanks 20 on the wearer's back.

In use, the tank 20 and other equipment are loaded on the user's back using a backpack, harness and the like, and the facepiece 26 is placed over the user's face such that it covers the user's mouth, nose or both, in conventional fashion. The hose assembly 30 is arranged to extend comfortably between the tank 20 or first stage regulator 22 and the facepiece 26, without interfering with the user's natural movements. When the tank's outlet valve 21 is opened, the user may then breathe normally via the SCBA 10 as he carries out his normal duties in the air-poor environments in which his work or other activities may take him.

During its operation, the hose assembly 30 is frequently subjected to a number of irregular forces. For example, the hose body 36 may be twisted, stretched, compressed, flexed and the like as the user moves. However, because the electrical wires 39 disposed therein are free to move longitudinally between the friction layer 48 and the outer layer 50 of the hose body 36, the hose assembly 30 thus provides considerable flexibility without affecting the structure of the hose body 36. Movement of the wires 39 within the grooves 49, 51 is further enhanced by the low coefficient of friction between the insulation material on the wires 39 and the materials used for the friction layer 48 and the outer layer 50 of the hose body 36. Further, the helical arrangement of the wires 39 allows the electrical harness to expand longitudinally without stretching the individual wires 39. Thus, as the hose assembly 30 is flexed, twisted and otherwise stretched, the layers of the hose body 36, which are all formed from materials having significant elastic properties, stretch naturally, while the coiled arrangement of wires 39 inside the hose body 36 is able to lengthen without imparting tension to the individual wires 39. Preferably, in order to accommodate sufficient expansion, the wires 39 are arranged to have a pitch (the length of hose required for one complete turn of the wire) that is approximately twice the diameter of the friction layer 48. For example, a hose having a typical central air passage 41 of just less than ¼ inch in diameter may have a friction layer 48 of approximately 7/16 inches and a wire pitch of ⅞ inch. Of course, the ratio of the wire pitch to the diameter of the friction layer 48 may be larger or smaller, but larger pitches limit the amount of expansion possible, while smaller pitches require greater lengths of wire.

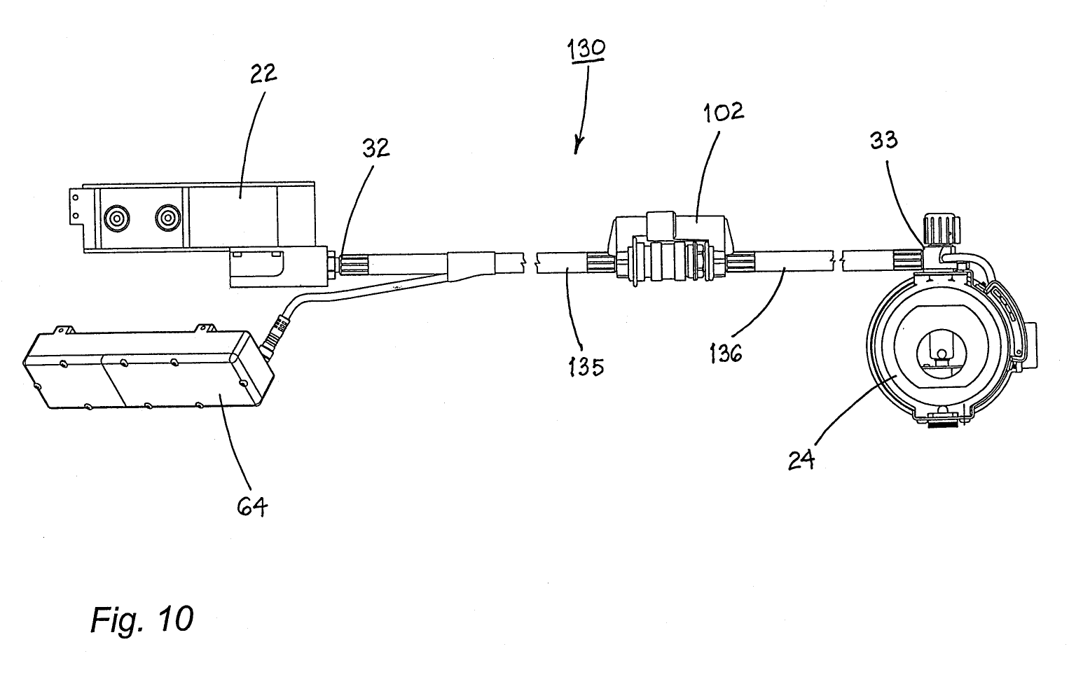

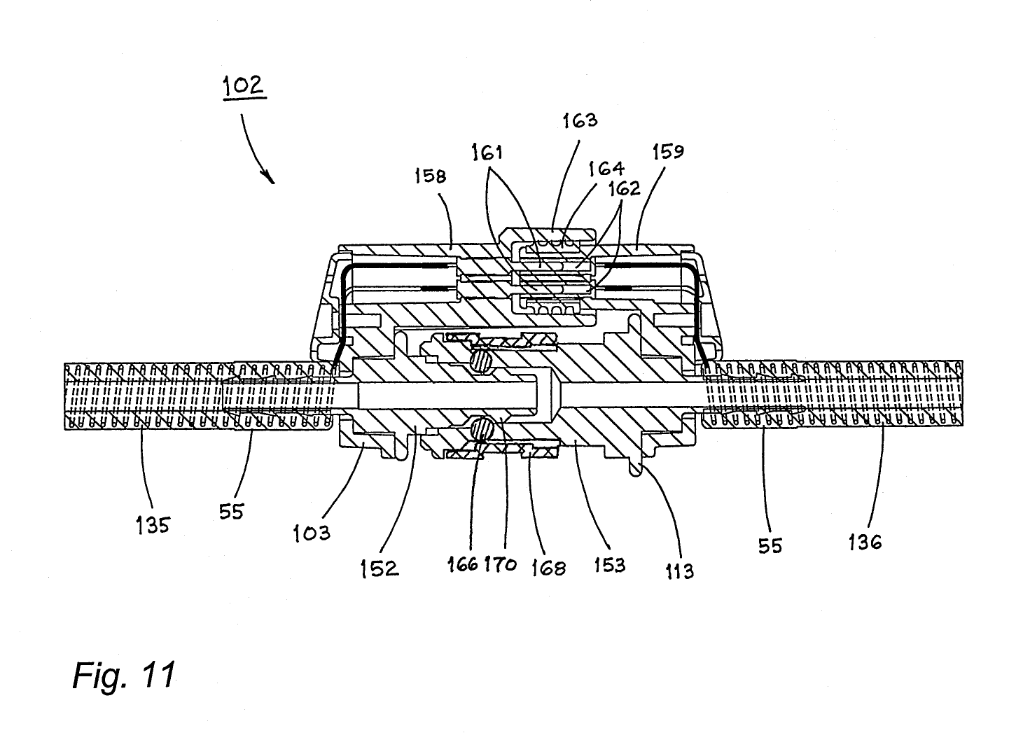

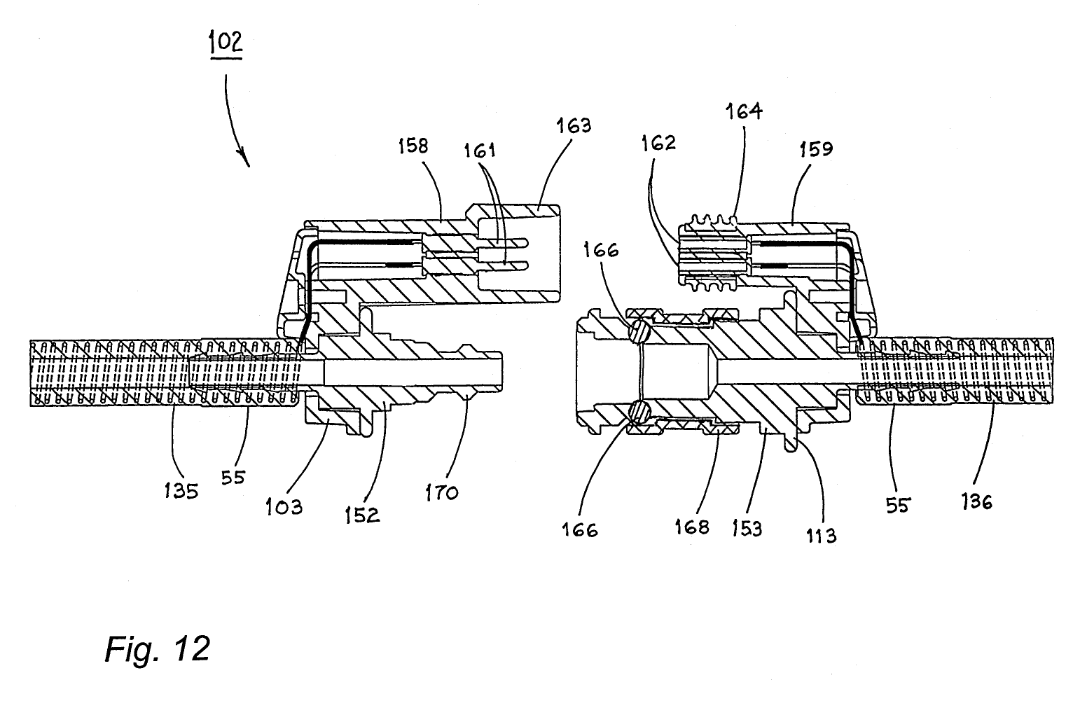

FIG. 10 is a perspective view of a hose assembly 130, in accordance with a second preferred embodiment of the present invention, interconnected with portions of the SCBA 10 of FIG. 1. This hose assembly 130 is identical to that of FIG. 2, except that it further includes a quick connect apparatus 102. FIGS. 11 and 12 are enlarged, fragmentary, reverse-angle cross-sectional views of the quick connect apparatus 102 of FIG. 10, shown in an engaged state and a disengaged state, respectively. The quick connect apparatus 102 includes two complementary connector assemblies 103, 113, each retained in the end of a respective hose segment 135, 136 via a ferrule 55. The first connector assembly 103 includes an air flow fitting 152 and an electrical connector 158. The pins 161 of the electrical connector 158 are surrounded by a shell 163 to protect the pins 161 from damage and to seal the electrical connection formed thereby from contact with water and other environmental dangers. The second connector assembly 113 includes a complementary air flow fitting 153 and a complementary electrical connector 159. The pin receptacles 162 are surrounded by a flexible accordion- or ribbed seal-type housing 164 formed from plastic, rubber or the like and sized to fit in the shell 163 under compression, thus completing the seal around the electrical connection.

Ball bearings 166, residing in openings in the end of the second air flow fitting 153, may be used to retain the tip of the first air flow fitting 152 in place. The ball bearings 166 may be moved into their engaged position by a spring-loaded sleeve 168, slidably mounted around the main body of the second air flow fitting 153, and held in place by compression created by a spring-loaded assembly (not shown) arranged around the air path inside the second air flow fitting 153. The ball bearings 166, sleeve 168 and spring-loaded assembly are all preferably formed from suitable metal materials.

To engage the quick connect apparatus 102, the two connector assemblies 103, 113 are positioned facing each other with the respective air flow fittings 152, 153 and electrical connectors 158, 159 aligned with each other, as shown in FIG. 12. As the connector assemblies 103, 113 are moved into engagement with each other, the pins 161 slide into the pin receptacles 162, and the tip of the first air flow fitting 152 engages the spring-loaded assembly inside the second air flow fitting 153. The spring mechanism of the sleeve 168 forces the sleeve 168 toward the first air flow fitting 152, forcing the ball bearings 166 into engagement with an annular ridge 170 extending around the tip, as shown in FIG. 11. To disengage the quick connect apparatus 102, additional compression may be applied to the two connector assemblies 103, 113, thus taking the sleeve 168 out of compression. The sleeve 168 may then be slid back along the second air flow fitting 153, allowing the ball bearings 166 to retract and enabling the removal of the first air flow fitting 152 from the second.

Based on the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to its preferred embodiment, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof. Although specific terms are employed herein, they are used in a generic and descriptive sense only and not for the purpose of limitation.

1.-31. (canceled)

32. A self-contained breathing apparatus (SCBA) comprising:
an SCBA pressure vessel for storing breathing air;
an electrical device;
an SCBA facepiece; and
an SCBA hose assembly comprising:
a body coupled between the pressure vessel and the facepiece, the body of the SCBA hose assembly comprising an inner surface and an outer surface, the inner surface defining a central air tube for delivering breathing air from the SCBA pressure vessel to the SCBA facepiece; and
an electrical wire disposed within the body of the SCBA hose assembly between the inner surface and the outer surface, the electrical wire being electrically connected to the electrical device.

33. The SCBA of claim 32, wherein the electrical wire extends along a helical path along the length of the body of the SCBA hose assembly.

34. The SCBA of claim 32, wherein the body of the SCBA hose assembly comprises:
an inner tube comprising the inner surface;
an intermediate layer surrounding the inner tube; and
an outer layer surrounding the intermediate layer and comprising the outer surface, wherein the electrical wire is disposed between the intermediate layer and the outer layer.

35. The SCBA of claim 32, wherein the electrical wire comprises a plurality of insulated electrical wires disposed within the body of the SCBA hose assembly between the inner and outer surfaces, the plurality of insulated electrical wires comprising at least one strand surrounded by an insulation layer, wherein the plurality of insulated electrical wires and corresponding insulation layers are spaced apart from one another within the body of the SCBA hose assembly.

36. The SCBA of claim 32, wherein the electrical wire comprises a plurality of insulated electrical wires disposed within the body of the SCBA hose assembly between the inner and outer surfaces, the plurality of insulated electrical wires comprising at least one strand surrounded by an insulation layer, wherein the insulation layer of each of the plurality of insulated electrical wires is detached from the insulation layers of the other insulated electrical wires within the body of the SCBA hose assembly.

37. The SCBA of claim 32, wherein the electrical wire comprises a plurality of insulated electrical wires disposed within the body of the SCBA hose assembly between the inner and outer surfaces, the plurality of insulated electrical wires comprising at least one strand surrounded by an insulation layer, wherein the insulation layer of each of the plurality of insulated electrical wires is disengaged from the insulation layers of the other insulated electrical wires within the body of the SCBA hose assembly.

38. The SCBA of claim 32, further comprising a controller, the electrical wire being electrically connected to the controller for conducting electricity between the electrical device and the controller.

39. The SCBA of claim 32, wherein the electrical device comprises an electrical signal generator coupled to the SCBA pressure vessel, the electrical signal generator being configured to generate at least one electrical signal on the basis of the remaining capacity of the SCBA pressure vessel.

40. The SCBA of claim 32, wherein the electrical device comprises at least one of a user interface, a heads up display, a microphone, a camera, a speaker, a display, a video capture device, a video display device, a vital sign sensor, a recording device, a controller, or a transceiver device.

41. The SCBA of claim 32, wherein the electrical device comprises a user interface at the SCBA facepiece, the SCBA further comprising an electrical signal generator coupled to the SCBA pressure vessel, the electrical signal generator being configured to generate at least one electrical signal on the basis of the remaining capacity of the SCBA pressure vessel, wherein the electrical wire is electrically connected to the electrical signal generator for conducting the electrical signal from the electrical signal generator to the user interface to indicate to a user the amount of breathing air remaining in the SCBA pressure vessel.

42. The SCBA of claim 32, wherein the electrical wire comprises a plurality of electrical wires disposed within the body of the SCBA hose assembly between the inner and outer surfaces, the plurality of electrical wires being arranged in a plurality of groups of at least two electrical wires, the plurality of groups of electrical wires being spaced apart from one another within the body of the SCBA hose assembly.

43. The SCBA of claim 32, wherein the body of the SCBA hose assembly comprises a groove formed therein, the electrical wire extending at least partially within the groove.

44. The SCBA of claim 32, wherein the body of the SCBA hose assembly comprises a layer defining an interior surface of the body, the electrical wire comprising a plurality of insulated electrical wires wrapped around the interior surface of the body between the inner and outer surfaces, wherein the plurality of insulated electrical wires are spaced uniformly apart from one another about the interior surface.

45. The SCBA of claim 32, wherein the body of the SCBA hose assembly comprises:
an inner tube comprising the inner surface;
a reinforcing sheath surrounding the inner tube;
an intermediate layer surrounding the reinforcing sheath; and
an outer layer surrounding the intermediate layer and comprising the outer surface, wherein the electrical wire is disposed between the intermediate layer and the outer layer.

46. A self-contained breathing apparatus (SCBA) comprising:
an SCBA pressure vessel for storing breathing air;
an electrical device;
an SCBA facepiece; and
an SCBA hose assembly comprising:
a body coupled between the SCBA pressure vessel and the SCBA facepiece, the body of the SCBA hose assembly comprising an inner tube, an intermediate layer surrounding the inner tube, and an outer layer surrounding the intermediate layer, the inner tube defining a central air passageway for delivering breathing air from the SCBA pressure vessel to the SCBA facepiece; and
a plurality of insulated electrical wires disposed within the body of the SCBA hose assembly between the intermediate layer and the outer layer, the plurality of insulated electrical wires comprising at least one strand surrounded by an insulation layer, wherein the plurality of insulated electrical wires and corresponding insulation layers are spaced apart from one another around a periphery of the intermediate layer, at least one of the plurality of insulated electrical wires being electrically connected to the electrical device.

47. The SCBA of claim 46, wherein the plurality of insulated electrical wires are arranged helically around the intermediate layer.

48. The SCBA of claim 46, wherein the insulation layer of each of the plurality of insulated electrical wires is detached from the insulation layers of the other insulated electrical wires.

49. The SCBA of claim 46, wherein the insulation layer of each of the plurality of insulated electrical wires is disengaged from the insulation layers of the other insulated electrical wires within the body of the SCBA hose assembly.

50. The SCBA of claim 46, further comprising a reinforcing sheath interposed between the inner tube and the intermediate layer.

51. A self-contained breathing apparatus (SCBA) comprising:
an SCBA pressure vessel for storing breathing air;
a controller configured to generate at least one electrical data signal;
an SCBA facepiece comprising a user interface; and
an SCBA hose assembly comprising:
a body coupled between the SCBA pressure vessel and the SCBA facepiece, the body of the SCBA hose assembly comprising an inner surface and an outer surface, the inner surface defining a central air tube for delivering breathing air from the SCBA pressure vessel to the SCBA facepiece; and
an electrical wire disposed within the body of the SCBA hose assembly between the inner surface and the outer surface, the electrical wire being electrically connected to the controller and the user interface and being configured to conduct the at least one electrical data signal from the controller to the user interface.
